(19) United States
(12) Patent Application Publication
(10) Pub. No.: US 2015/0212362 A1
(43) Pub. Date: Jul. 30, 2015

(54) DISPLAY DEVICE

(71) Applicant: Mitsubishi Electric Corporation, Tokyo (JP)

(72) Inventor: Kazutada TAKAIRA, Tokyo (JP)

(73) Assignee: Mitsubishi Electric Corporation, Tokyo (JP)

(21) Appl. No.: 14/597,484

(22) Filed: Jan. 15, 2015

(30) Foreign Application Priority Data
Jan. 30, 2014 (JP) 2014-015288

(51) Int. Cl. G02F 1/1333

(52) U.S. Cl. CPC G02F 1/133308; G02F 1/13338; G02F 2001/133331

(57) ABSTRACT

A display device of the present invention includes a display element having a display surface, a frame that houses the display element and has an opening exposing the display surface, a plurality of adhesive members linearly bonded with gaps therebetween to a surface on a periphery of the opening of the frame along the opening, the surface being opposite to the display element, a touch panel that is fixed to the frame through the adhesive members so as to cover the opening, and a resin that is applied to the frame so as to fill the gaps and is in contact with the touch panel.

### BACKGROUND OF THE INVENTION

1. Field of the Invention

The present invention relates to a display device including a protective plate of a display element or a touch panel.

2. Description of the Background Art

In recent years, as information electronic devices become widespread, display devices including protective members and touch panels with ruggedness on front surfaces of liquid crystal panels are widespread (for example, see Japanese Patent Application Laid-Open No. 10-161087 (1998)). Display equipment including the display device prevents deteriorating visibility due to surface reflection of external light. Furthermore, to protect the display device from an external impact, submersion, and dust, the touch panel and the protective member of the display device are integrated by bonding (glass bonding) with an adhesive layer in some cases. The touch panel and the protective member being integrated are fixed to a liquid crystal display device with adhesive members.

However, in a case where the adhesive members are intermittently disposed without forming a closed curve, the broken places between both sides bonded with the adhesive members form gaps, resulting in the entry of foreign matter into the interior.

For example, in the display device of Japanese Patent Application Laid-Open No. 2011-180483, the liquid crystal display panel and the backlight part are bonded with the adhesive members, but the adhesive members are not disposed in the corners of the inner frame of the backlight part. Thus, the gaps are formed between the liquid crystal display panel and the backlight part, resulting in the entry of foreign matter.

### SUMMARY OF THE INVENTION

The present invention has been made in view of the above-mentioned problems, and an object thereof is to provide a display device that suppresses an entry of foreign matter into the interior from a gap between a frame of a display element and a protective member of the display element or a touch panel, the frame and the protective member or the touch panel being bonded with adhesive members.

A display device of the present invention includes a display element having a display surface, a housing, a plurality of adhesive members, a plate-shaped member, and a resin. The housing houses the display element and has an opening exposing the display surface. The plurality of adhesive members are linearly bonded with gaps therebetween to a surface on a periphery of the opening of the housing along the opening, the surface being opposite to the display element. The plate-shaped member is fixed to the housing through the adhesive members so as to cover the opening. The resin is applied to the housing so as to fill the gaps and is in contact with the plate-shaped member. The plate-shaped member is a protective plate of the display element or a touch panel.

In the display device of the present invention, the plurality of adhesive members are linearly bonded with gaps therebetween along the opening of the housing, the plate-shaped member is fixed to the housing through the adhesive members so as to cover the opening, and the resin is applied to the housing so as to fill the gaps and is in contact with the plate-shaped member. Therefore, the plate-shaped member and the housing are bonded without the gaps with the adhesive members and the resin, suppressing the entry of foreign matter into the interior.

### BRIEF DESCRIPTION OF THE DRAWINGS

FIG. 1 is an exploded perspective view of a display device according to a first preferred embodiment of the present invention;

FIG. 2 is a plan view of the display device according to the first preferred embodiment of the present invention;

FIG. 3 is a cross-sectional view taken along an A-A line of FIG. 2;

FIG. 4 is a plan view of a display device according to a second preferred embodiment of the present invention; and

FIG. 5 is a cross-sectional view taken along a B-B line of FIG. 4.

### DESCRIPTION OF THE PREFERRED EMBODIMENTS

### A. First Preferred Embodiment

<A-1. Configuration>

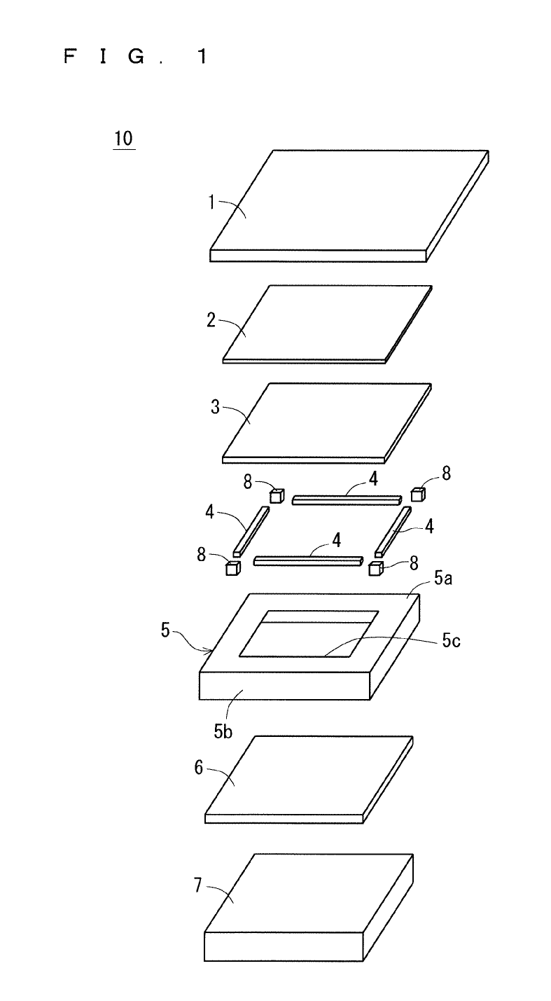

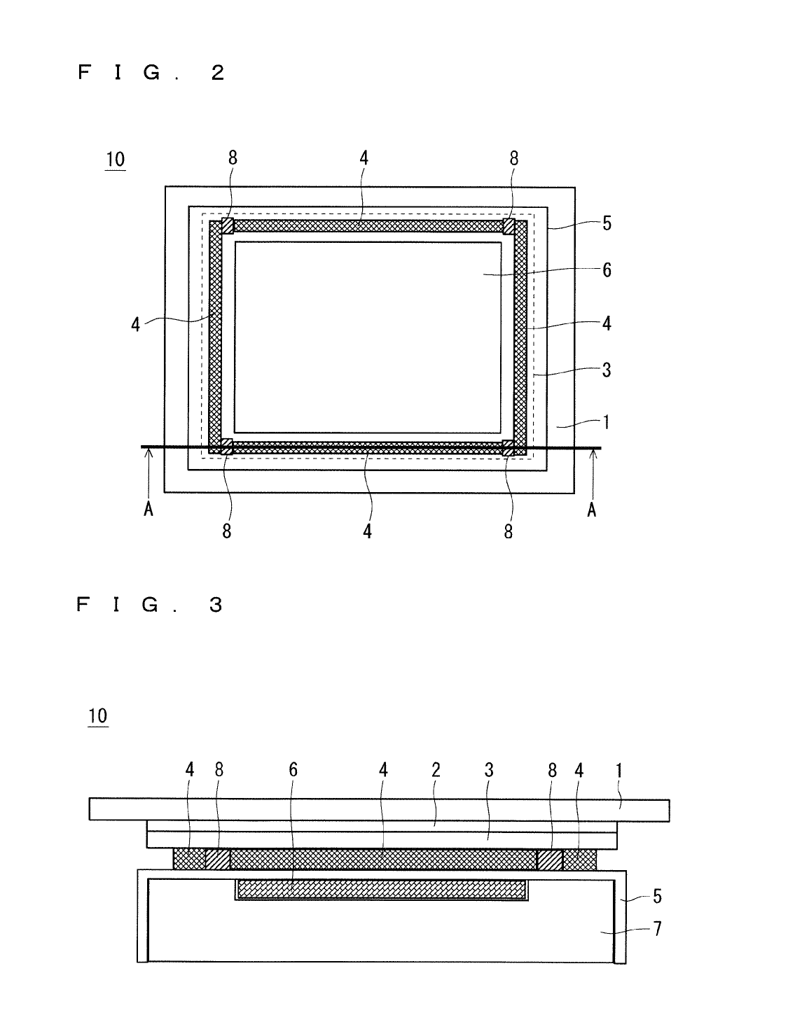

FIG. 1 is an exploded perspective view of a display device 10 according to a first preferred embodiment of the present invention. FIG. 2 is a plan view of the display device 10. FIG. 3 is a cross-sectional view taken along an A-A line of FIG. 2.

The display device 10 includes a protective member 1, an adhesive 2, a touch panel 3, adhesive members 4, a frame 5, a display element 6, a planar light source device 7, and resins 8.

The display element 6 has a display surface on a front surface thereof. In the specification, the display element 6 is described as a liquid crystal panel below, and the other display element such as a plasma display panel may be used. The display element 6 being the liquid crystal panel applies birefringence of liquid crystals and includes a counter substrate and a TFT array substrate. The counter substrate includes, for example, a colored layer, a light-shielding layer, and a counter electrode formed on an insulating substrate made of a glass or the like. The TFT array substrate includes, for example, a pixel electrode and a thin film transistor (TFT) that is to be a switching element formed on an insulating substrate made of a glass or the like.

In addition, the display element 6 includes spacers that maintain a distance between the counter substrate and the TFT array substrate, a sealing compound that bonds both the substrates, liquid crystals that are sandwiched between both the substrates, a sealing material that seals an opening for injecting the liquid crystals, and an alignment film and a polarizing plate that align the liquid crystals.

The planar light source device 7 includes a light source that emits light and a mold frame that holds a light guide plate for transmitting the light emitted from the light source. The planar light source device 7 is disposed on a back surface of the display element 6 and irradiates the light from the back surface side of the display element 6.

The touch panel 3 is formed of a circuit including a transparent electrode formed on a transparent substrate. The touch panel 3 converts information related to position coordinates input from the outside (operator) into an electric signal, and the electric signal is transmitted to a control circuit (not shown) of a final product from an output wiring member. The touch panel 3 of the preferred embodiment can adopt a projection capacitance type, for example. The touch panel 3 of the projection capacitance type detects the position (contact position) of the operator's fingertip or the like to measure the ratio between the amount of current based on the electrode pattern of the contact position and the amount of current based on a plurality of electrode patterns around the contact position. The position of the fingertip or the like is accurately detected to input the signal. A transparent glass or the like may be adopted as substrates forming a top and a bottom of the touch panel 3.

The protective member 1 is a touch panel protecting plate disposed on a front surface of the touch panel 3 to prevent damage, deformation, wear, and soiling due to an external pressure or a contact to the touch panel 3. The protective member 1 is formed of a generally transparent material such as a glass or a plastic. In the specification, it is described below that the protective member 1 is a glass that has high strength and is hardly deformed. From the viewpoint of preventing deformation and damage, the protective member 1 is thicker than the touch panel 3, and it is preferable that the protective member 1 is approximately more than twice as thick as the touch panel 3, for example. Moreover, a front surface or a back surface of the protective member 1 is printed or coated, whereby a function as a design member can be added. The protective member 1 is bonded and fixed on the front surface of the touch panel 3 with the adhesive 2 to form an input member.

The frame 5 has a front plate portion 5a and four side plate portions 5b extending from a periphery of the front plate portion 5a to a back side (back surface side) thereof. The back surface side of the frame 5 is formed open and includes the display element 6 and the planar light source device 7 housed therein. The front plate portion 5a has a frame shape provided with an opening 5c, and the display surface of the display element 6 is exposed from the opening 5c. In other words, the light from the display surface of the display element 6 can pass through the opening 5c to the front surface side of the frame 5. The front plate portion 5a covers the periphery of the front surface of the planar light source device 7 and the four side plate portions 5b cover the side surfaces of the planar light source device 7, thereby having the configuration that minimizes the light leaked to the outside except from the opening 5c of the frame 5. Resin materials such as a polycarbonate (PC) and an acrylonitrile butadiene styrene (ABS) other than metal materials such as aluminum, stainless steel, and iron may be adopted as a material for the frame 5.

The adhesive members 4 are members that bond the front plate portion 5a (front surface) of the frame 5 and a surface (back surface) of the touch panel 3 facing the frame 5. The touch panel 3 is fixed to the frame 5 through the adhesive members 4 so as to cover the opening 5c. Double-sided tapes, for example, may be adopted as the adhesive members 4. In this case, the adhesive member 4 includes a base material and adhesive surfaces on both sides of the base material sandwiched therebetween. A foam such as a polyolefin, an acrylic material, or a polyurethane material may be adopted as the base material. The base material itself may have adhesiveness.

As shown in FIGS. 2 and 3, the adhesive members 4 are disposed on the periphery of the opening 5c of the frame 5 and are also disposed on an inner peripheral portion of the surface of the touch panel 3 being the input member, the surface facing the frame 5. More specifically, the adhesive members 4 are linearly bonded to the front plate portion 5a in four places correspondingly to each side of the rectangular opening 5c, the adhesive members 4 being provided with certain gaps therebetween so as not to overlap each other. In a case where the adhesive members 4 are formed of the double-sided tapes, the adhesive members 4 may be formed into a frame shape but may be formed into a rectangular shape in some cases in terms of costs of materials. In this case, if the adhesive members 4 are disposed in the closed curve along the opening 5c of the frame 5, a combination of the plurality of adhesive members 4 is needed to be disposed. As a result, the gaps are formed between the plurality of adhesive members 4.

One surfaces of the adhesive members 4 are bonded to the front plate portion 5a of the frame 5 while the other surfaces of the adhesive members 4 are bonded to the periphery of the surface of the touch panel 3 facing the frame 5. It should be noted that the plurality of adhesive members 4 are disposed with the above-mentioned gaps therebetween, so that corners of the front plate portion 5a of the frame 5 and corners of the touch panel 3 corresponding to the corners of the front plate portion 5a are not provided with the adhesive members 4.

The resins 8 are applied on the front plate portion 5a of the frame 5 so as to fill the gaps between the adhesive members 4. One surfaces of the resins 8 are bonded to the frame 5 while the other surfaces of the resins 8 are bonded to the periphery of the surface of the touch panel 3 facing the frame 5. In a case where a photocurable resin is used as the resins 8, the resins 8 can be cured by ultraviolet light after being applied.

<A-2. Modifications>

The description is given above of the display device 10 including the touch panel 3. However, the display device 10 may not include the touch panel 3 and have a configuration that a protective plate of the display element 6, instead of the touch panel 3, is fixed to the frame 5 through the adhesive members 4 so as to cover the opening 5c. With this configuration, the resins 8 fill the gaps between the adhesive members 4, thereby eliminating the gap between the protective plate and the frame 5. This can eliminate an entry path of foreign matter into the opening 5c of the frame 5. Moreover, even if the frame 5 is pulled towards the opposite side from the protective plate of the display element 6 in a state of being fixed, the end portions of the adhesive members 4 can be prevented from being peeled off.

The opening 5c of the frame 5 has a rectangular shape, so that the adhesive members 4 are disposed in four places correspondingly to each side of the opening 5c, but it is not limited to the four places as long as the adhesive members 4 are disposed on the front plate portion 5a along the opening 5c. The gaps formed between the adhesive members 4 are also not limited in the corners of the touch panel 3 and may be anywhere.

<A-3. Effects>

The display device 10 of the first preferred embodiment includes the display element 6 having the display surface, the frame 5 (housing) that houses the display element 6 and has the opening 5c exposing the display surface, the plurality of adhesive members 4 linearly bonded with gaps therebetween to the surface on the periphery of the opening 5c of the frame 5 along the opening 5c, the surface being opposite to the display element 6, the plate-shaped member that is fixed to the frame 5 through the adhesive members 4 so as to cover the opening 5c, and the resins 8 that are applied to the frame 5 so as to fill the gaps between the adhesive members 4 and is in contact with the plate-shaped member. The plate-shaped member is the protective plate of the display element 6 or the touch panel 3. The resins 8 fill the gaps between the adhesive members 4, which eliminates the gap between the frame 5 and the plate-shaped member that are bonded to each other. This can eliminate the entry path of foreign matter into the opening 5c of the frame 5. The resins 8 fill the gaps between the adhesive members 4. That is to say, the resins 8 cover the end portions of the adhesive members 4. Therefore, even if the frame 5 is pulled towards the opposite side (back side) from the plate-shaped member in a state of being fixed, the end portions of the adhesive members 4 can be prevented from being peeled off, the adhesive members 4 being disposed between the plate-shaped member and the frame 5.

In a case where the opening 5c has a rectangular shape and the four adhesive members 4 are disposed along the four sides of the opening 5c, the gaps are formed in the corners of the surface of the plate-shaped member facing the frame 5. However, the resins 8 fill the gaps, achieving the effects described above.

In a case where the adhesive members 4 are formed of the double-sided tapes, the double-sided tapes may be formed into a frame shape but may be formed into a rectangular shape in some cases in terms of cost of materials. In this case, if the adhesive members 4 are disposed in the closed curve along the opening 5c of the frame 5, a combination of the plurality of adhesive members 4 is needed to be disposed. As a result, the gaps are formed between the plurality of adhesive members 4. However, the resins 8 fill the gaps, achieving the effects described above.

### B. Second Preferred Embodiment

<B-1. Configuration>

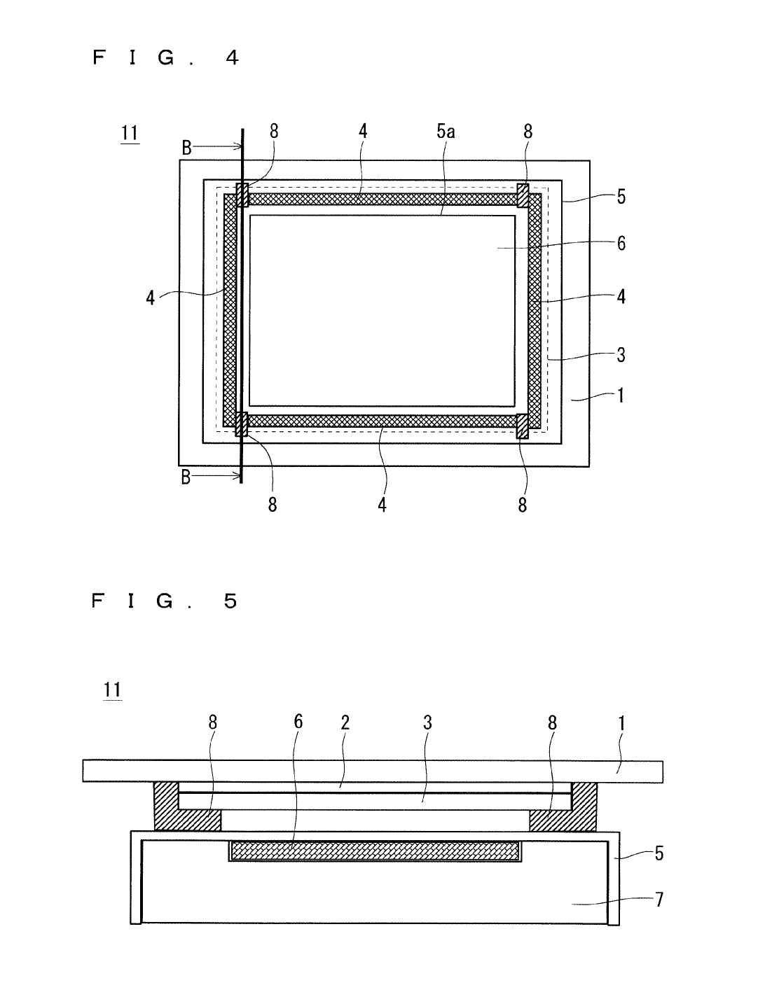

FIG. 4 is a plan view of a display device 11 according to a second preferred embodiment. FIG. 5 is a cross-sectional view taken along a B-B line of FIG. 4. In the second preferred embodiment, the same components as those described in the first preferred embodiment are denoted by the same references, which are not described here.

In the first preferred embodiment, the resins 8 are applied in the gaps between the adhesive members 4. In the second preferred embodiment, as shown in FIGS. 4 and 5, the resins 8 are applied in the gaps between the adhesive members 4 and are continuously applied on the protective member 1. Thus, the protective member 1 is fixed to the frame 5 through the resins 8.

<B-2. Effects>

In the display device 11 according to the second preferred embodiment, the touch panel 3 is fixed to the frame 5 through the adhesive members 4 so as to cover the opening 5c, the touch panel protecting plate is located opposite to the frame 5 of the touch panel 3, the outer periphery of the touch panel 3 is fixed to the frame 5 through the adhesive members 4, and the resins 8 are in contact with the touch panel protecting plate. Therefore, in addition to the effects of the first preferred embodiment, the protective member 1 and the touch panel 3 are reinforced to prevent the protective member 1 from being peeled off in a case where force is applied in a direction that causes the adhesive 2 to be peeled off.

In addition, according to the present invention, the above preferred embodiments can be arbitrarily combined, or each preferred embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device, comprising:
a display element having a display surface;
a housing that houses said display element and has an opening exposing said display surface;
a plurality of adhesive members linearly bonded with gaps therebetween to a surface on a periphery of said opening of said housing along said opening, the surface being opposite to said display element;
a plate-shaped member that is fixed to said housing through said adhesive members so as to cover said opening; and
a resin that is applied to said housing so as to fill said gaps and is in contact with said plate-shaped member,
wherein said plate-shaped member is a protective plate of said display element or a touch panel.

2. The display device according to claim 1, wherein
said opening has a rectangular shape, and
said adhesive members are four said adhesive members along four sides of said opening and have said gaps in corners of a surface of said plate-shaped member, the surface facing said housing.

3. The display device according to claim 2, said plate-shaped member being said touch panel,
the display device further comprising a touch panel protecting plate located opposite to said housing of said touch panel, wherein
an outer periphery of said touch panel is fixed to said housing through said adhesive members, and
said resin is in contact with said touch panel protecting plate.

4. The display device according to claim 1, wherein said adhesive members are double-sided tapes.
